(19) United States
(12) Patent Application Publication
(10) Pub. No.: US 2009/0158939 A1
(43) Pub. Date: Jun. 25, 2009

(54) Toaster

(76) Inventor: Timothy Jacob Jensen, Højslev (DK)

Correspondence Address: JAMES C. WRAY, 1493 CHAIN BRIDGE ROAD, SUITE 300, MCLEAN, VA, 22101, US

(21) Appl. No.: 12/083,112

(22) PCT Filed: Oct. 6, 2006
(86) PCT No.: PCT/DK2006/000564

§ 371 Date: Apr. 4, 2008

(30) Foreign Application Priority Data
Oct. 6, 2005 (EP) 05021773.6

(51) Int. Cl. A47J 37/08

(52) U.S. Cl. 99/389

(57) ABSTRACT

The present invention relates to a toaster (1) comprising a number of side panels (2), each provided with a number of heating elements (14), a number of end panels (3, 4) and a base part (5), where the side panels (2) and the end panels (3, 4) are connected to the base part (5), wherein each of the side panels (2) at a lower edge part is pivotally hinged to the base part (5) and adapted to be unfolded and folded between vertical and horizontal positions of use, respectively.

### FIELD OF THE INVENTION

The present invention relates to a toaster comprising a number of side panels, each provided with a heating element, a number of end panels and a base part, where the side panels and the end panels are connected to the base part wherein each of the side panels at a lower edge part is pivotally hinged to the base part and adapted to perform a pivotal movement to be unfolded and folded between vertical and horizontal positions of use, respectively which toaster furthermore comprises a vertical displaceable carrier member, which is arranged between the side panels.

### BACKGROUND OF THE INVENTION

In everyday meals (e.g. breakfast, brunch, lunch, dinner etc.) bread (e.g. white bread, rye bread, bagels, buns, rolls, toast bread, pita, French loaf, pan cakes etc.) constitutes a significant part.

Some people prefer to toast bread to enhance the flavour or improve the taste of e.g. stale bread.

In general two main types of electrical toasters exist; a vertical toaster and a flat bed toaster.

In principle the vertical toaster functions by placing a bread on a vertical displaceable carrier, which is arranged in a slot between two side panels, each provided with heating elements, hence the vertical displaceable bread carrier is brought into the toaster to position the bread between the side panels. After toasting, the carrier can be released automatically or manually and the toasted bread is brought up and is ready to serve.

In principle the flat bed toaster functions by placing bread on or above a heating surface to toast one side of the bread at the time.

The vertical toaster and the flat bed toaster are generally used for the same purpose, however, for some purposes one kind of toaster is used in preference to the other.

On the one hand the vertical toaster toasts the bread on both sides at the same time, hence it is time-saving in relation to the flat bed toaster and furthermore it provides toasted bread, which is evenly toasted on both sides. However, the bread inserted in the vertical toaster can only be of a certain thickness.

On the other hand the flat bed toaster may e.g. be used to toast bread on one side only, and it can be used to toast bread (e.g. baguettes, buns, etc.) with a thickness preventing it from being inserted into a vertical toaster.

To obtain the advantages of both toasters it is necessary to acquire both a vertical toaster and a flat bed toaster. However, toasters are not necessarily cheap and two toasters take up unnecessary storage space in the kitchen.

Accordingly it has earlier been proposed to provide a toaster that can be used as a vertical toaster or a flat bed toaster. Examples are known e.g. from the description of U.S. Pat. No. 1,687,712, U.S. Pat. No. 1,912,353 and DE 25 04 678. However, the toasters known from these prior art documents are difficult to transform from the vertical toaster mode into the flatbed toaster mode. It will require a manual handling and or use of a combination of different activation means in order to transform the toaster from one mode to another.

### OBJECT OF THE INVENTION

It is the object of the present invention to provide an improved toaster, which can be used either as a vertical toaster or as a flat bed toaster, which is easier to use and which automatically is transformed into either the vertical toaster mode or the flat bed toaster mode without the need of manipulating more activation devices.

The object is achieved with a toaster as described in the preamble of claim 1 and where the toaster furthermore comprises a displacement means for the carrier member, which displacement means comprises at least one electric device connected with the carrier member to effect the displacement thereof and that said electric device when using the toaster in the horizontal position of use is provided as a part of an activation device for the pivotal movement of the side panels.

### DESCRIPTION OF THE INVENTION

According to a preferred embodiment of the invention the toaster comprises a number of side panels, each of which are provided with a number of heating elements, a number of end panels and a base part, where the side panels and the end panels are connected to the base part.

When used as a vertical toaster, both the side panels and the end panels are parallel to each other and arranged opposite each other, and the side panels are arranged between the end panels, thus providing a slot between them wherein the bread can be arranged.

When used as a flat bed toaster, the side panels are arranged side-by-side, thus the heating elements provide a flat heating surface. According to a first embodiment of the present invention the carrier member is arranged between the side panels and according to a second embodiment of the present invention there is no space between the side panels, hence providing a flat, coherent heating surface. The end panels are arranged parallel to each other and arranged opposite each other, and the side panels are arranged between the end panels.

To transform the toaster into a vertical toaster and back to a flat bed toaster again, each of the side panels is at a lower edge part pivotally hinged to the base part and adapted to be unfolded and folded between vertical and horizontal positions of use, respectively.

The pivotal hinging of each of the side panels at a lower edge part causes the side panel's upper edge to move outwards and downwards to reach a horizontal position, where the side panel's upper and lower edge is level, and the side panel is horizontally positioned.

The pivotal hinging of each side panel at a lower edge part may in said second embodiment be shaped in such way that it allows horizontal movement of the side panels, so the lower edge parts of the side panels are moved together, thus providing a flat coherent heating surface. According to this second embodiment of the present invention the heating surface is a flat coherent surface hence it is possible to obtain even toasting of the bread on a flat bed toaster, although the bread overlaps the side panels.

The base part is used as support for the toaster panels regardless of whether the toaster is a vertical or a flat bed toaster. The base part can be provided with extra load to move the point of gravity downwards, thus preventing the toaster from tumbling. Furthermore, the base part can be used for directing wires/cables between the end panels and/or to contain different mechanical arrangements.

When functioning as a vertical toaster the bread is arranged between the vertical side panels. To prevent the bread from disappearing between the side panels, in which case the bread is difficult to get hold of again without having to open the toaster, the toaster furthermore comprises a vertical displaceable carrier member, which is arranged in between the side panels, when the toaster is used as a vertical toaster. The displaceable carrier member may be of a type, which is well known in prior art vertical toasters for securing that the bread pops up from the toaster for a person easily to grip it.

The carrier member ensures that the bread is supported, and typically the carrier member has at least two vertical positions. In a first position a part or the entire bread projects upwards from the toaster, thus making it easy to insert/remove the bread. In a second position the carrier member has moved down between the side panels, and the bread is completely submerged in the toaster, thus ensuring even toasting of the bread loaf.

To move the carrier member vertically between the side panels, the toaster furthermore comprises a displacement means for the carrier member. Preferably said displacement means comprises a magnet valve or a motor.

When using the toaster according to the present invention in the vertical toaster mode, the electric device which is connected to the carrier member is actuated, simply through activation of a button. Hereby the carrier member effects the displacement of the displacement means. The displacement means preferably comprise a motor, which is connected to a gear connected to a rack, which is connected to the carrier member whereby the carrier member will be raised or lowered together with the movement of the rack. Accordingly the rack and the pinion drive will effect the displacement of the carrier member when activating the motor for rotation in either one or the other direction. This is usable for a toaster for use in the vertical mode.

Using a toaster a control device is associated with the motor. This control device comprises an electronic or mechanical timer. The timer will preferably be electronic. The timer will activate the motor after a certain time in order to cause a displacement of the carrier to raise the toasted bread. The timer function will be connected with heating means whereby the heating means are turned simultaneously with the raising of the carrier member.

When using the toaster in the horizontal toaster mode the electric device is provided as a part of the activation device for the pivotal movement of the side panels. Thereby it is possible only to make use of the activation device and thereby ensure that the side panels are unfolded to the horizontal position and simultaneously the displaceable carrier member is lowered to the same level as the flatbed toaster. Preferably in this situation the electric device will be a magnet valve. The magnet valve is activated through a button whereby a solenoid will liberate a locking mechanism for the side panels. The side panels may swing to the horizontal position either through the action from a spring or through the action of a motor.

It is preferred that the locking mechanism comprises two rotational lever members, which are in one end arranged for engagement with a side panel and in the other end it is arranged for engagement with a locking rod of the magnet valve. Accordingly the activation of the magnet valve will retract a locking rod from an engagement with the rotational lever members. The rotation of the levers around the pivot pin makes it possible to free the side panels from the vertical locked position. The locking rod constitutes a part of the locking device and is preferably connected with a solenoid in the magnet valve. The locking rod will preferably be activated by a spring maintaining it in a locking position, when the magnet valve is not activated.

In this situation the electrical valve would be indirectly connected to the carrier member seeing that an electric connection of the valve with the motor would cause a simultaneous actuation of the magnet valve to cause the pivotal movement of the side panels and the activation of the motor in order to lower the carrier member to be arranged at the same level as the side panel. It is only needed to activate a button for the combined movement of the side panels and the carrier member.

In this situation the control unit will still maintain the timer function connected with the heating means. However, the control unit will disengage the timer function from activating the motor when the bread is toasted. Accordingly when a prescribed time for toasting the bread is ended the timer function will turn off the heating means without activating the motor and the toaster will still be in the horizontal position of use.

It is preferred to effect the folding movement of the side panels to a manual actuating of the side panels in order to effect the pivotal movement to the vertical position of use. This folding will preferably cause the activation of a torsion spring and when the side panels are brought to their vertical position in which they will be locked to the engagement with a part of the rotational lever members the torsion spring will be load. Accordingly another use in the horizontal position of use is automatically effected in activating a button as explained above. The torsion spring swings in a secure way the side panels to the horizontal position of use.

Preferably the pivotal movement is effected around hinges, which are provided with damping in order to provide a smooth pivotal movement. In this embodiment each of the side panels are connected with a gear wheel segment for the panel opening movement and which gear wheel segments cooperate with a small socket comprising the torsion spring for movement speed reduction of the pivotal movement of the side panels.

In order to ensure that the control unit automatically detects whether the toaster is provided in the vertical toaster mode or the flat bed toaster mode a sensor is provided which gives a signal to the control unit. The sensor may detect the position of the side panel directly or indirectly. Accordingly the position sensor may be arranged for the detection of the position of the gear wheel segment for detecting the position of the rotational lever members.

Each of the rotational lever members will have the end arranged for engagement with the side panel provided with an inclined face cooperating with a hole or notch in the side panel. When moving the side panel to the vertical position an edge of the hole or notch in the side panel will cooperate with the inclined face of the lever thereby causing a small pivotal movement allowing the end of the lever to go into a snap engagement with the notch or hole in the side panel and thereby maintaining the side panel in the vertical position against the action of the above-mentioned torsion spring which tends to pivot the side panel to the horizontal position.

According to one embodiment of the present invention said activation device for the pivotal movement of the side panels comprises two rotational lever members each having one end arranged for engagement with a side panel and the other end arranged for engagement with a locking rod which is also a part of the activation device.

Said displacement means may also comprise slide and release means. According to such embodiment of the present invention the slider may be visible and attached to either the end panels or the side panels, and it is mechanically connected to the carrier member so vertical movement of the slider results in a similar vertical movement of the carrier member.

According to one embodiment of the present invention the slider causes an engagement of the carrier member or the slider when moved to the bottom of the space between the side panels, thus preventing the slider from moving upwards.

This engagement of the carrier member or the slider is released by a release means, which can be activated by a release button, arranged visibly on either the end panels or the side panels, or by a timer which is set when the carrier member is engaged.

In any embodiment the displacement means comprises an electric device, preferably comprising a motor, which, when activated, moves the carrier member vertically up and down between the side panels.

To transform the toaster into a vertical toaster and back into a flat bed toaster, one end panel comprises activation means for the pivotal unfolding and/or folding of the side panels.

According to one embodiment of the present invention the activations means comprises a button, which, when pushed, releases the engagement of the side panels and so the side panels start moving pivotally from a vertical, parallel position to a horizontal position, thus providing a flat bed toaster.

The return of the side panels from the horizontal side-by-side position to the vertical, parallel position is carried out manually. To pivotally move the side panels in a controlled manner the activation means e.g. comprises springs, chock absorbers, and/or sprocket wheels.

In an alternative embodiment of the present invention the activations means comprises an activation button, which, when pushed a first time, activates a motor, which moves the side panels from the vertical, parallel position to the horizontal position, and when the button is pushed a second time, the motor moves the side panels from the horizontal position to the vertical, parallel position.

To transform the toaster into a flat bed toaster with a flat heating surface, the carrier member is in one embodiment of the present invention adapted to move into a position between the side panels.

In an alternative embodiment of the present invention the carrier member is adapted to move into a low or hidden position in the base part, thus allowing the side panels to move pivotally and connect in the toaster midpoint.

The movement of the carrier member occurs at the same time or slightly before the side panels are moved pivotally. When the toaster transforms back into a vertical toaster, the carrier member again moves up to the first upper position between the side panels, hence making it possible to arrange bread on the carrier member.

To optimise the toasting one end part comprises a heating element control panel. This control panel makes it possible to control and/or adjust the toasting process. E.g. it is possible to select and/or re-select the mode of toasting (e.g. normal, defrosting, reheating), control the heating elements (e.g. by looking at the colour of the bread) and to set and/or reset a timer (e.g. toasting/grill time). Preferably said one end part of the toaster comprises said activation means for the pivotal unfolding and/or folding of the side panels and said displacement means for the carrier member.

To enhance the toaster user friendliness and to ensure the correct toasting process for the different types of bread, the control panel comprises a visual indicator. Because of this indicator, e.g. a display, it is possible to tell e.g. the mode of toasting, the degree of browning and/or the toasting/grill time. An alternative to a display is a number of light indicators, where the light patterns indicate the aforementioned parameters.

To protect the electrical installations and the control panel from the heat, which is generated from the heating elements during use, the end panels comprise a heat protection wall, which is made of a material with a low heat coefficient and e.g. is made of ceramic, glass, gypsum, fibres or the like.

According to a preferred embodiment of the present invention both end panels comprise a heat protection wall, thereby protecting electrical installations and/or the control panel in either end panel.

Like many ordinary kitchen appliances the toaster according to the present invention is run by electricity, thus the toaster must be connected to the electricity grid. Hence the toaster is provided with a cord and a plug.

The cord is of a substantial length, typically 0.5-2.0 meters, making it possible to position and use the toaster from a distance of the plug outlet. To prevent the cord from taking up space on the table, the toaster is provided with a cord compartment, where the excess cord can be curled up and hidden.

For safety reasons it is important to place the toaster securely on the surface, thereby preventing impacts from moving or tumbling the toaster. Therefore the base part comprises a rubber foot, which provides a cord compartment.

As an alternative to a rubber foot any kind of foot with at least one surface facing down will do, where the surface facing down has a high friction resistance coefficient or is slightly adhesive. The foot can therefore be formed of alternative materials such as wood, plastic, metal, glass or the like.

When toasting bread the surface of the bread is heated and demoisturised, thus the bread crumbles, when moved up and down in the vertical toaster or when turned on the flat bed toaster. To collect these crumbles the base part comprises a removable crumb tray, which is adapted to be removed for emptying or cleaning.

The crumb tray is arranged in connection with the base part to allow the collection of the crumbles from the vertical toaster. When the toaster is a flat bed toaster, the crumbles falling into the side panels during toasting are collected by the crumb tray when the side panels are folded back to upright position during the transforming of the flat bed toaster into a vertical toaster.

### DESCRIPTION OF THE DRAWING

The invention is explained in more details in the following with reference to the figures, where:

FIG. 1-3 show a vertical toaster according to the invention,

FIG. 4-6 show a flat bed toaster according to the invention,

FIG. 7 shows a rubber foot of a toaster according to the invention,

FIG. 8 shows the transformation from vertical toaster to flat bed toaster,

FIG. 9 shows the crumb tray,

FIG. 10 shows a vertical toaster with parts removed in order to illustrate displacement means for the carrier member,

FIG. 11 shows a picture corresponding to FIG. 10, however illustrated from the outside of the toaster,

FIG. 12 shows a picture from the same angle as illustrated in FIG. 10, however with the cover provided on the end part and illustrating the carrier member,

FIG. 13 shows a partial view of elements of the actuation device for the pivotal movement of the side panels, and

FIG. 14 shows an enlarged and more detailed picture of some of the parts illustrated in FIG. 13.

### DETAILED DESCRIPTION OF THE INVENTION

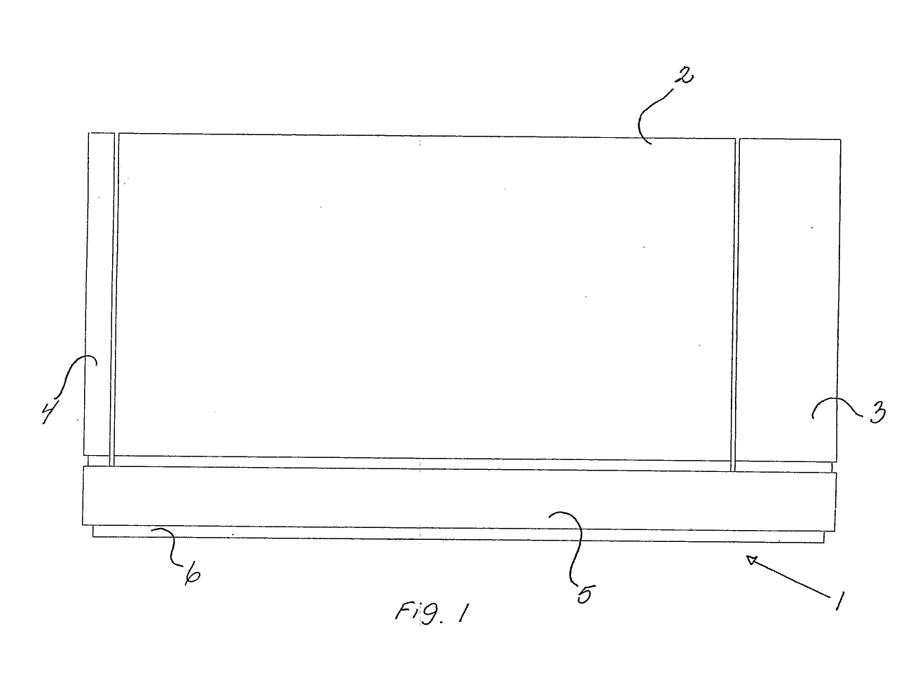

FIG. 1-3 show a vertical toaster 1.

The toaster 1 comprises side panels 2, each of which is provided with a heating element (not shown), end panels 3, 4 and a base part 5, where the side panels 2 and the end panels 3, 4 are connected to the base part 5, which is provided with a rubber foot 6. As an alternative to the illustrated rubber foot, it is possible to use a number of separate feet.

The end panel 3 is at the side surface provided with the slider 7 for the carrier member 11 and an eject button 8 for the crumb tray (not shown). The end panel 3 is at the top surface provided with a control panel 9, which is provided with a display 12. Hence it is possible to e.g. choose a variation of toasting programs concurrent with visual information readable of the display 12.

The end panel 3 is at the top surface provided with a button 10 to activate the trans-formation of the toaster 1 from vertical toaster to flat bed toaster.

From FIG. 3 it is possible to see the carrier member 11, which is arranged between the side panels 2. The vertical movement of the carrier member 11 is determined by movement of the slider 7 illustrated in FIG. 2.

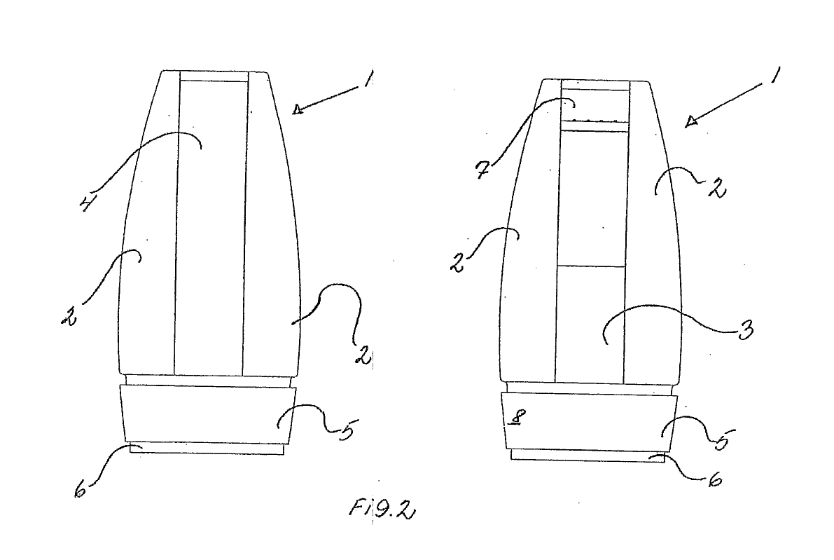

FIG. 4-6 shows a flat bed toaster 1. The side panels 2 are pivotally moved down to a horizontal position, where the side panels 2 provide an upwards facing flat heating surface 15, where the side panels 2 are separated by the carrier member 11. Each side panel 2 is provided with a number of heating elements 14.

FIG. 6 shows that each end panel 3, 4 is provided with a heat protection wall 13, which protects the electrical and mechanical components (not shown) arranged inside the end panels 3, 4.

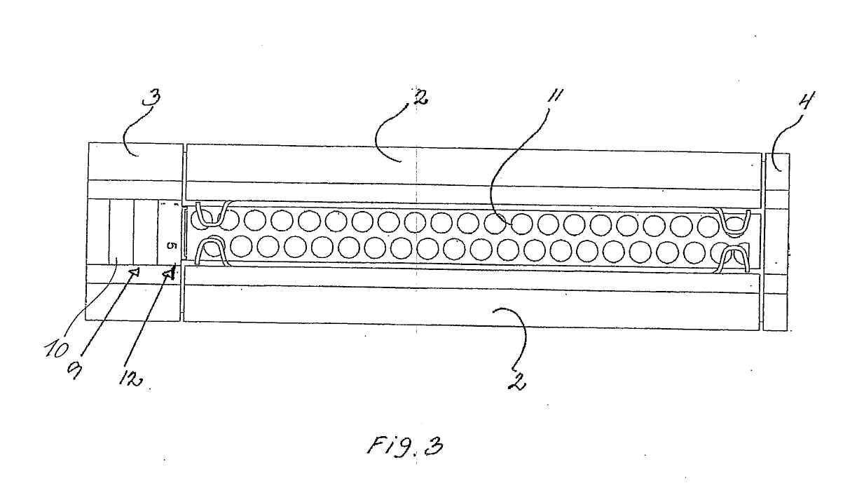

FIG. 7 shows the rubber foot 6 attached to the bottom of the base part 5. The rubber foot provides a cord compartment 18, wherein a wire clamp 17 is attached onto the bottom of the base part 5. The cord 16 can now be winded around the wire clamp 17 and the length of the cord 16 can be customised.

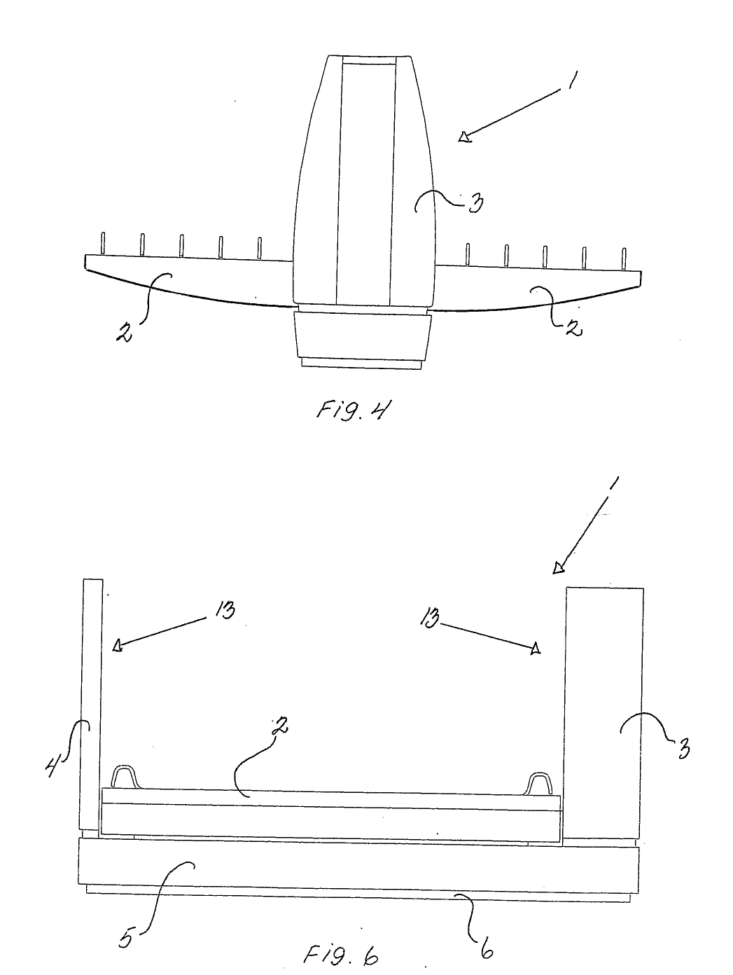

FIG. 8 shows the transformation from vertical toaster to flat bed toaster. When using a vertical toaster, the bread slices 20 are positioned on the carrier member (not shown), and the slider 7 is moved to the bottom of the toaster 1 and e.g. during the toasting the slider moves upwards until the bread slices 20 are toasted and ready to serve.

When using a flat bed toaster the side panels 2 are pivotally moved down to a horizontal position, and buns 21 or bread slices 20 are positioned on the coherent heating surface 15. To enhance the flavour on both sides of the buns 21 or bread slices 20 it is necessary to manually turn over the buns 21 or bread slices 20.

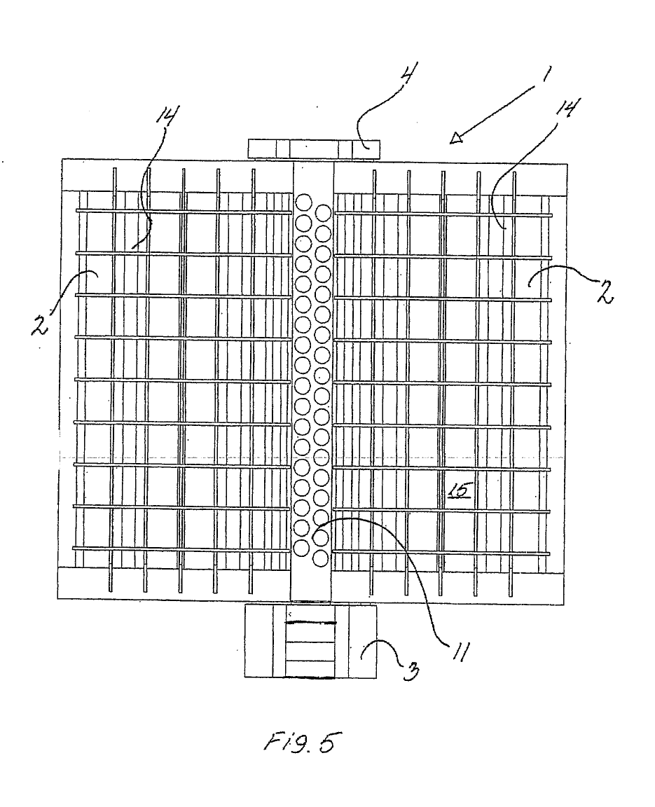

FIG. 9 shows the crumb tray 22, which is arranged inside the base part 5, and the crumb tray 22 can be removed by pushing an eject button (not shown) on base part 5. The crumb tray 22 must be removed and cleaned at regular time intervals.

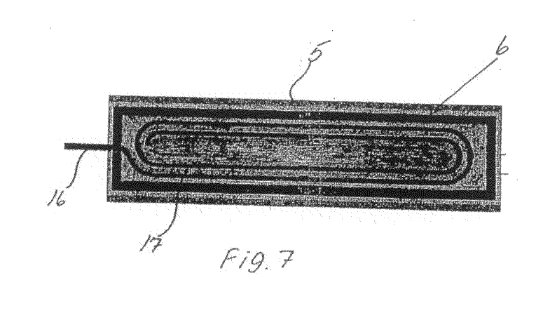

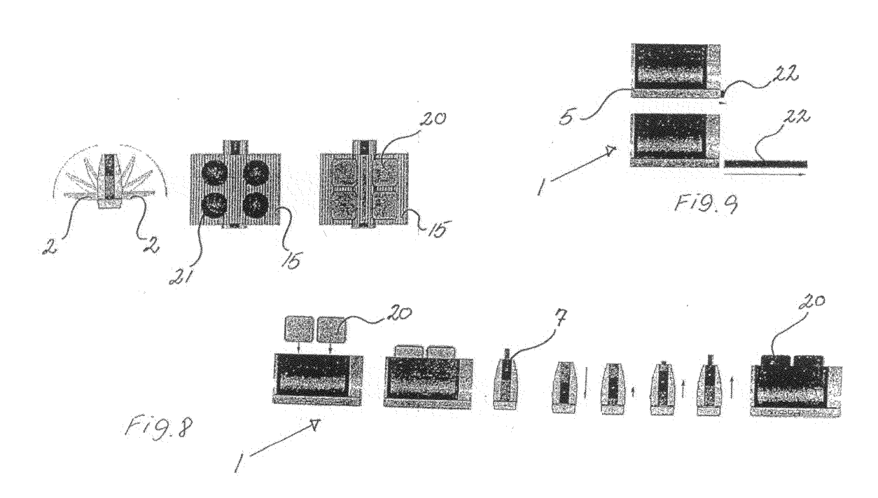

FIG. 10 shows that the end part 3 of the toaster comprises a motor 23 which has an output shaft 24 with a gear 25. The gear 25 is connected with a rack 26 and the rack 26 is connected to the carrier member 11. The motor 23 is activated through a button 27, which is illustrated in FIG. 11. The button 27 is arranged at the top surface of the end panel 3 in a position close to the button 10 and the control panel 9. FIG. 11 also illustrates a magnet valve 28 which is activated through the action of the button 10.

Furthermore, FIG. 11 illustrates two gear wheel segments 29 for opening movement of the side panels 2. Furthermore, a sprocket 30 is illustrated which comprises a torsion spring 31 and which is provided as a damped sprocket in order for movement speed reduction during the pivotal movement of the side panels 2.

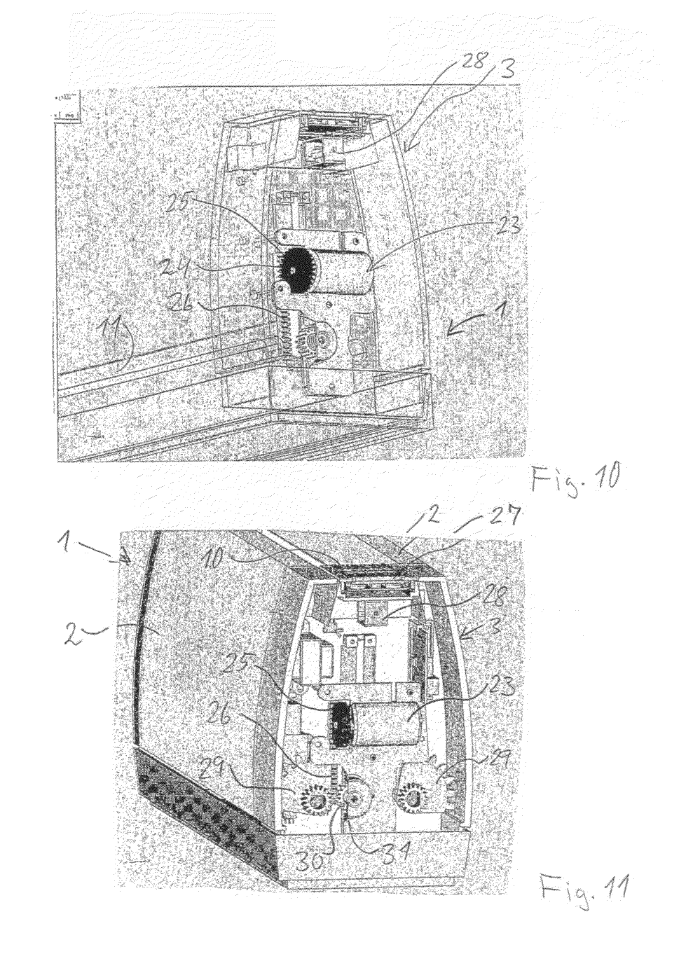

FIG. 12 illustrates the carrier member 11 being guided on a guide pin 32 arranged in the end panel 3. The carrier member is affixed to the rack 26 which comprises a sleeve 33 which is guided on the guide pin 32.

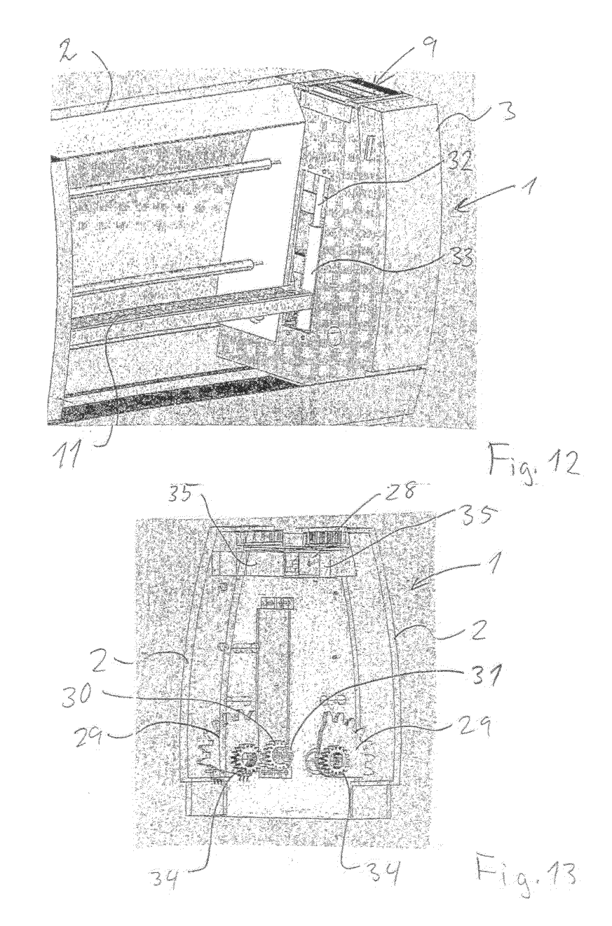

FIG. 13 illustrates the gear wheel segments 29 associated with the side panels 2 for the opening movement thereof. Each of the gear wheel segments 29 comprises a gear 34, which cooperates with the sprocket 30. Furthermore, the magnet valve 28 is illustrated, which cooperates with two release levers 35 for the side panels 2.

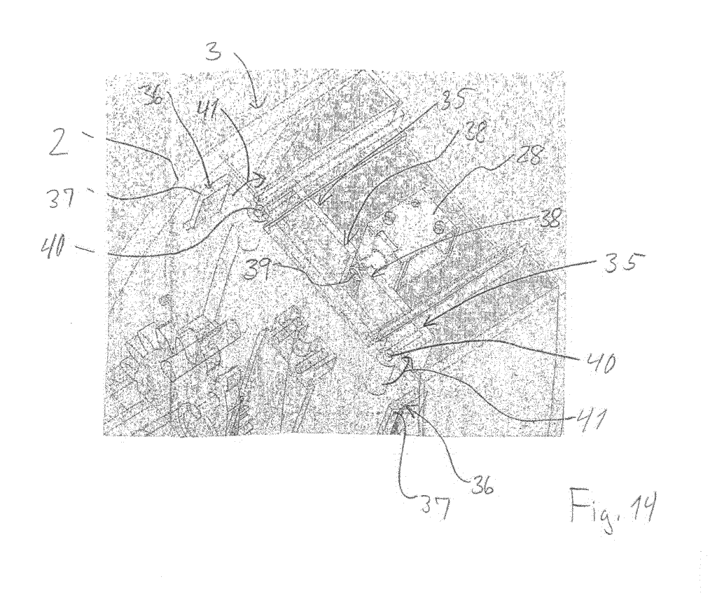

FIG. 14 more clearly illustrates the release levers 35. Each of the release levers 35 has a first end 36 with an inclined surface 37 arranged for engagement with a notch (not illustrated) in the side panel 2. The release lever has a second end 38 arranged for engagement with a locking rod 39, which is activated with a magnet valve 28. The locking rod 39 is urged against its extended position between the two end parts 38 of the levers by a spring. An activation of the solenoid of the magnet valve 28 will retract the locking rod 39 thereby allowing a pivotal movement of the release levers 35 around a pivot pin 40.

When pivoting in a direction according to the arrows 41 the side panels may pivot to their horizontal positions through the action of the torsion spring 31. The pivotal movement is damped due to the damping effect obtained in the sprocket 30.

When folding the side panels 2 to the vertical position the engagement notch in the side panel will cooperate with the inclined surface 37 and cause a small pivoting movement of the lever causing the end of the lever to go into a locking engagement with the notch or hole in the side panel whereby the side panel again will be maintained in the locked vertical position.

It should be noted that the locking rod 39 will only be retracted for short while when activating the button on the top surface of the end panel 3. Accordingly the normal position will be an extended position in which the locking rod has an outermost end in a locking position between the two end parts 38 which hinder the pivotal movement of the release levers 35.

1. Toaster (1) comprising a number of side panels (2), each provided with a number of heating elements (14), a number of end panels (3,4) and a base part (5), where the side panels (2) and the end panels (3, 4) are connected to the base part (5), wherein each of the side panels (2) at a lower edge part is pivotally hinged to the base part (5) and adapted to perform a pivotal movement to be unfolded and folded between vertical and horizontal positions of use, respectively which toaster (1) furthermore comprises a vertical displaceable carrier member (11), which is arranged between the side panels (2), wherein the toaster (1) furthermore comprises a displacement means for the carrier member (11), which displacement means comprises at least one electric device connected with the carrier member (11) to effect the displacement thereof and that said electric device when using the toaster in the horizontal position of use is provided as a part of an activation device for the pivotal movement of the side panels (2).

2. Toaster (1) according to claim 1, wherein said displacement means comprises a magnet valve or a motor.

3. Toaster (1) according to claim 1, wherein said activation device for the pivotal movement of the side panels comprises two rotational lever members each having one end arranged for engagement with a side panel and the other end arranged for engagement with a locking rod which is also a part of the activation device.

4. Toaster (1) according to claim 1, wherein one end part (3) of the toaster comprises said activation means for the pivotal unfolding and/or folding of the side panels (2) and said displacement means for the carrier member (11).

5. Toaster (1) according to claim 1, wherein the side panels (2) are made of a heat resistant and/or a see-through material.

6. Toaster (1) according to claim 1, wherein one end part (3) comprises a control panel (9) for the heating element (14).

7. Toaster (1) according to claim 6, wherein the control panel (9) comprises a visual indicator (12).

8. Toaster (1) according to claim 1, wherein the end panels (3, 4) comprise a heat protection wall (13).

9. Toaster according (1) to claim 1, wherein the base art (5) comprises a rubber foot (6), which provides a cord compartment (18).

10. Toaster (1) according to claim 1, wherein the base part (5) comprises a removable crumb tray (22).
